(19) United States
(12) Patent Application Publication
(10) Pub. No.: US 2017/0312871 A1
(43) Pub. Date: Nov. 2, 2017

(54) ASSEMBLY STRUCTURE OF HEAT PIPE AND VAPOR CHAMBER AND ASSEMBLY METHOD THREREOF

(71) Applicant: TAIWAN MICROLOOPS CORP., New Taipei City (TW)

(72) Inventor: Chun-Hung LIN, New Taipei City (TW)

(21) Appl. No.: 15/143,534

(22) Filed: Apr. 30, 2016

(51) Int. Cl. B23P 15/26

(52) U.S. Cl. CPC B23P 15/26; B23P 2700/09

(57) ABSTRACT

An assembly structure of a heat pipe and a vapor chamber and an assembly method thereof are provided. The structure includes a vapor chamber, a heat pipe, a porous sintered structure, and a working fluid. The vapor chamber includes a lower housing and an upper housing, a cavity is formed between the upper housing and the lower housing, and the upper housing includes a through hole and a circular wall. The heat pipe includes an opening. The open end of the heat pipe is disposed perpendicularly corresponding to the circular wall and communicates with the through hole. A block portion is formed on the heat pipe close to the opening. The porous sintered structure is formed between the through hole and the block portion. The working fluid is filled into the cavity.

### TECHNICAL FIELD

The present invention relates to a heat conduction technique and, in particular, to an assembly structure of a heat pipe and a vapor chamber and an assembly method thereof.

### BACKGROUND

With the development in the computing speed of electronic components, the heat generated from the electronic components becomes higher and higher. In order to solve the high heat generation problem, the industry extensively utilizes vapor chambers and heat pipes having good heat conduction properties. However, improvement should be made for current vapor chambers and heat pipes for good heat conduction efficiency, low production costs, and ease of production.

In a conventional assembly structure of a vapor chamber and a heat pipe, a heat pipe is normally disposed perpendicularly on the vapor chamber. The heat pipe does not communicate with the vapor chamber, and heat can only be conducted and dissipated away by means of heat conduction. Such a structure cannot achieve uniform temperature distribution for the vapor chamber and the heat pipe, and as a result, the heat conduction efficiency is greatly compromised. In solution, the industry utilizes a through hole formed on the vapor chamber to connect the heat pipe. However, the manufacturing process is troublesome and complicated, and a working fluid inside does not have a good circulation effect, so improvement is required to solve the above-mentioned problems.

### SUMMARY

It is an object of the present invention to provide an assembly structure of a heat pipe and a vapor chamber and an assembly method thereof, thereby simplifying a manufacturing process and also improving heat conduction and heat dissipation efficiency.

Accordingly, the present invention provides an assembly method of a heat pipe and a vapor chamber, comprising steps of:

a) preparing a metal board and processing the metal board to form a through hole and a circular wall;

b) preparing a heat pipe, the heat pipe including an opening, processing the heat pipe to form a block portion;

c) arranging the heat pipe to be perpendicular corresponding to the circular wall to allow the opening to communicate with the through hole;

d) inserting a core rod into the through hole to be blocked by the block portion;

e) filling a metallic powder into an outer periphery of the core rod from the through hole;

f) performing a sintering process on a half-finished product of step e) to form a porous sintered structure between the through hole and the block portion and form an upper housing;

g) preparing a lower housing and sealing the lower housing with respect to the upper housing; and

h) performing a fluid filling process and a degassing sealing process on the half-finished product of step g).

Accordingly, the present invention provides an assembly structure of a heat pipe and a vapor chamber, comprising a vapor chamber, a heat pipe, a porous sintered structure, and a working fluid. The vapor chamber includes a lower housing and an upper housing sealed with respect to each other. A cavity is formed between the upper housing and the lower housing; the upper housing includes a through hole and a circular wall extending from a circumference of the through hole. The heat pipe includes an opening, the heat pipe is disposed perpendicularly corresponding to the circular wall and in communication with the through hole by means of the opening, and a block portion is formed on the heat pipe close to the opening. The porous sintered structure is formed between the through hole and the block portion. The working fluid is filled into the cavity.

The present invention further includes the following functions. By utilizing the porous sintered structure connected to the first capillary structure and the second capillary structure, a good circulation of the working fluid inside is achieved.

### BRIEF DESCRIPTION OF THE DRAWINGS

The disclosure will become more fully understood from the detailed description and the drawings given herein below are for illustration only, and thus does not limit the disclosure, wherein:

FIG. 1 is a method flowchart according to the present invention;

FIG. 2 is a cross-sectional view of the present invention, showing a metal board according to the present invention;

FIG. 3 is a cross-sectional view of the present invention, showing the metal board after formation processing;

FIG. 4 is a cross-sectional view of the present invention, showing a heat pipe after formation processing;

FIG. 5 is a cross-sectional view of the present invention, showing assembly of the metal board, the heat pipe and a core rod;

FIG. 6 is a cross-sectional view showing metallic powders filled into a through hole and an inner surface of the metal board;

FIG. 7 is a cross-sectional view of the present invention, showing an upper housing and a lower housing assembled with respect to each other;

FIG. 8 is a cross-sectional view according to another embodiment of the present invention;

FIG. 9 is an exterior view showing the heat pipe according to another embodiment of the present invention; and

FIG. 10 is a cross-sectional view showing the heat pipe according to still another embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

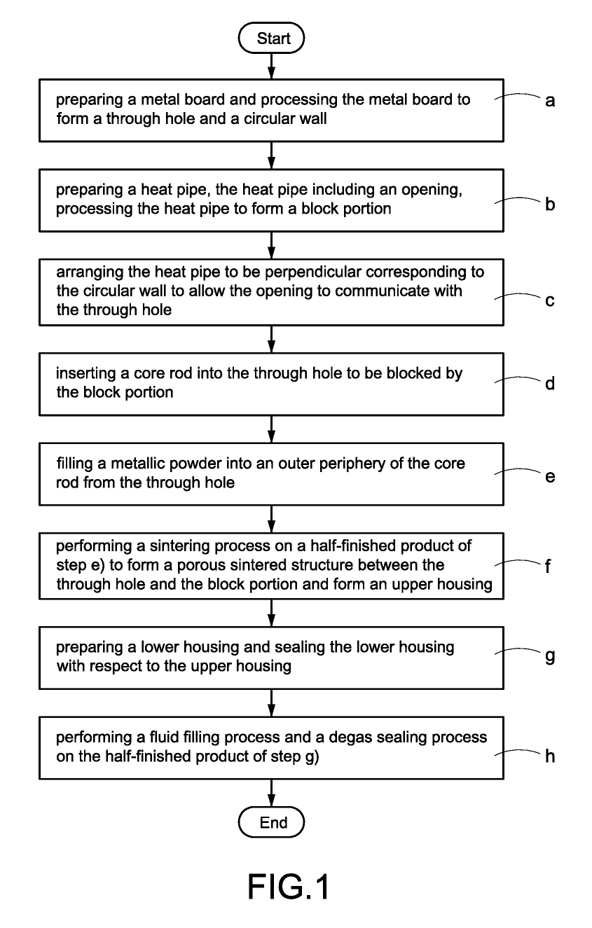

Referring to FIGS. 1 to 7, the present invention provides an assembly method of a heat pipe and a vapor chamber, comprising steps as follows:

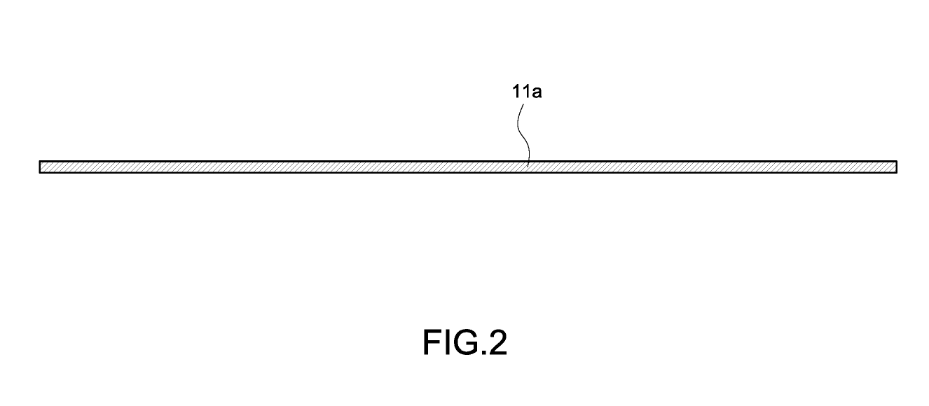

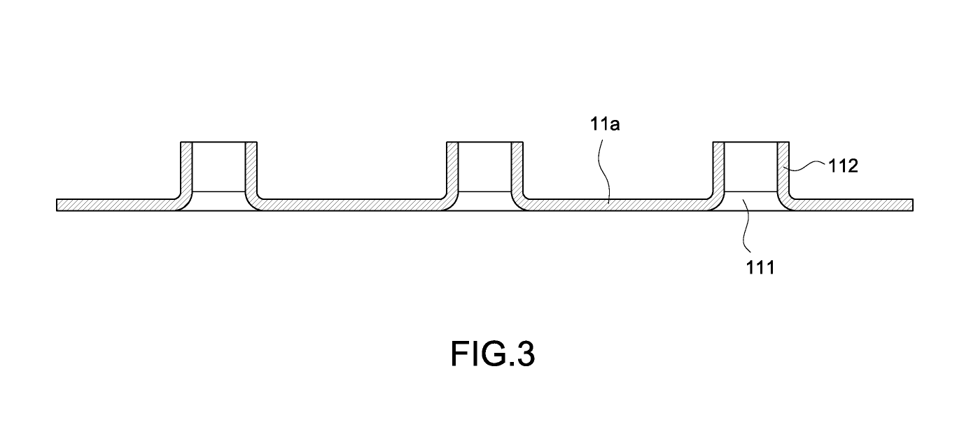

a) A metal board 11a is prepared, and the metal board 11a is processed to form a through hole 111 and a circular wall 112. Referring to FIGS. 2 and 3, in this step, the metal board 11a can consist of aluminum, copper or alloy thereof. A mold (not illustrated) is utilized to perform a forming-hole and extension process on the metal board 11a, so as to form a plurality of through holes 111 on the metal board 11a and a circular wall 112 extending from a circumference of each of the through holes 111. The number of the through holes 111 can vary as required; a miniaturized heat dissipation device can also include only one through hole 111.

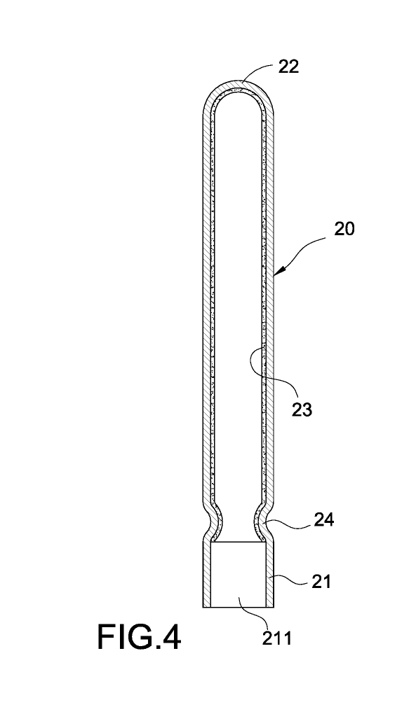

b) A heat pipe 20 is prepared, the heat pipe 20 includes an opening 211, and the heat pipe 20 is processed to form a block portion 24. Referring FIG. 4, step b) can be performed before or after step a). The heat pipe 20 in this step can consist of aluminum, copper or alloy thereof. The heat pipe 20 includes an open end 21 and a close end 22 away from the open end 21. The open end 21 includes an opening 211, a second capillary structure 23 is disposed inside the heat pipe 20, and the second capillary structure 23 can be a metallic woven web, a porous sintered powder element or a groove portion. A jig (not illustrated) is used to form a block portion 24 at the open end 21 of the heat pipe 20 close to the opening 211. There is a distance of 0.5 to 10 millimeters between the block portion 24 and an edge of the open end 21. In the present embodiment, the block portion 24 is an annular recess.

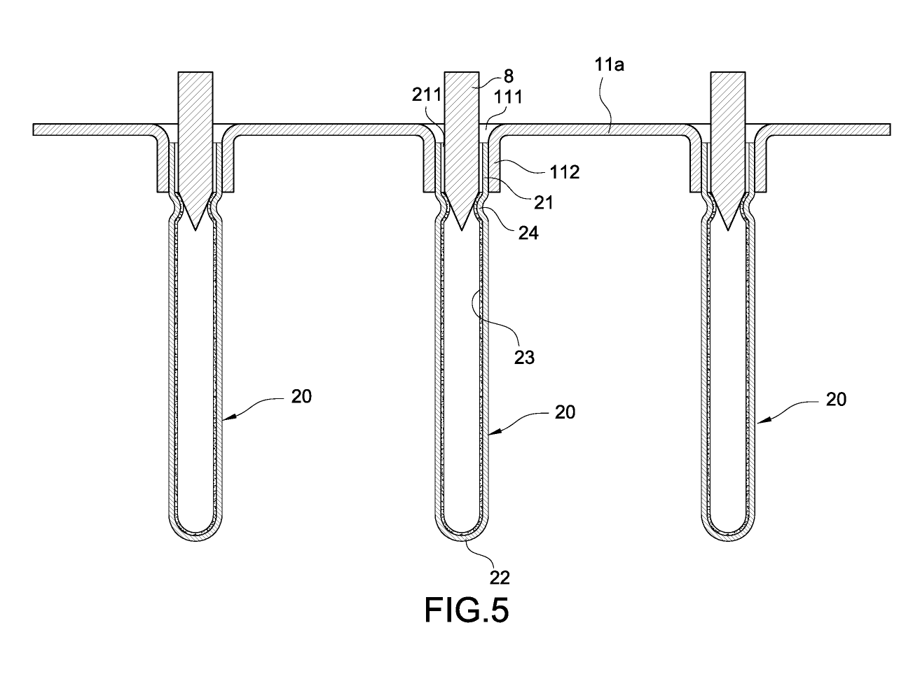

c) The heat pipe 20 is disposed perpendicularly corresponding to the circular wall 112 to allow the opening 211 to communicate with the through hole 11. Referring to FIG. 5, in this step, an adhesive (e.g. a solder paste, not illustrated) is applied onto an outer circumferential surface of the open end 21 of the heat pipe 20, and then the open end 21 of the heat pipe 20 is inserted with respect to the circular wall 112 for connection, so as to allow the opening 211 to communicate with the through hole 111. In this embodiment, the open end 21 is disposed inside the circular wall 112.

d) A core rod 8 is inserted from the through hole 111 and blocked by the block portion 24. Referring to FIG. 5, in this step, a core rod 8 is inserted into the opening 211 from the through hole 111 and the open end 21 of the heat pipe 20 and is blocked by the block portion 24 to be positioned.

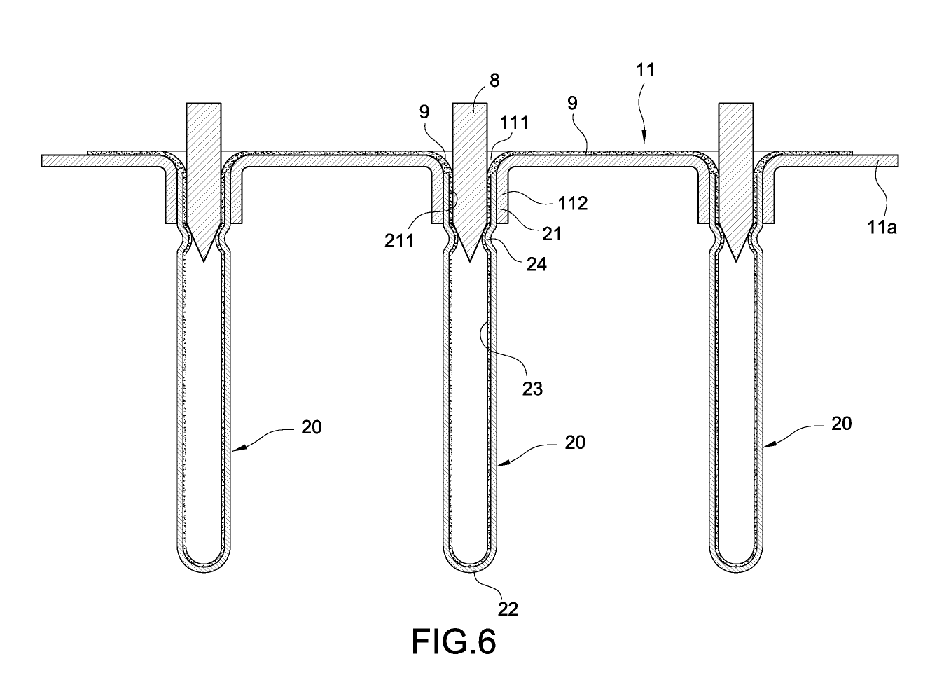

e) A metallic powder 9 is filled into an outer periphery of the core rod 8 from the through hole 111. Referring to FIG. 6, in this step, the metallic powder 9 is filled from the through hole 111 into the outer periphery of the core rod 8 between the core rod 8 and an inner surface of the open end 21. At the same time, the metallic powder 9 can be sprayed on an inner surface of the metal board 10 to form a first capillary structure 13. The first capillary structure 13 is a porous sintered powder element.

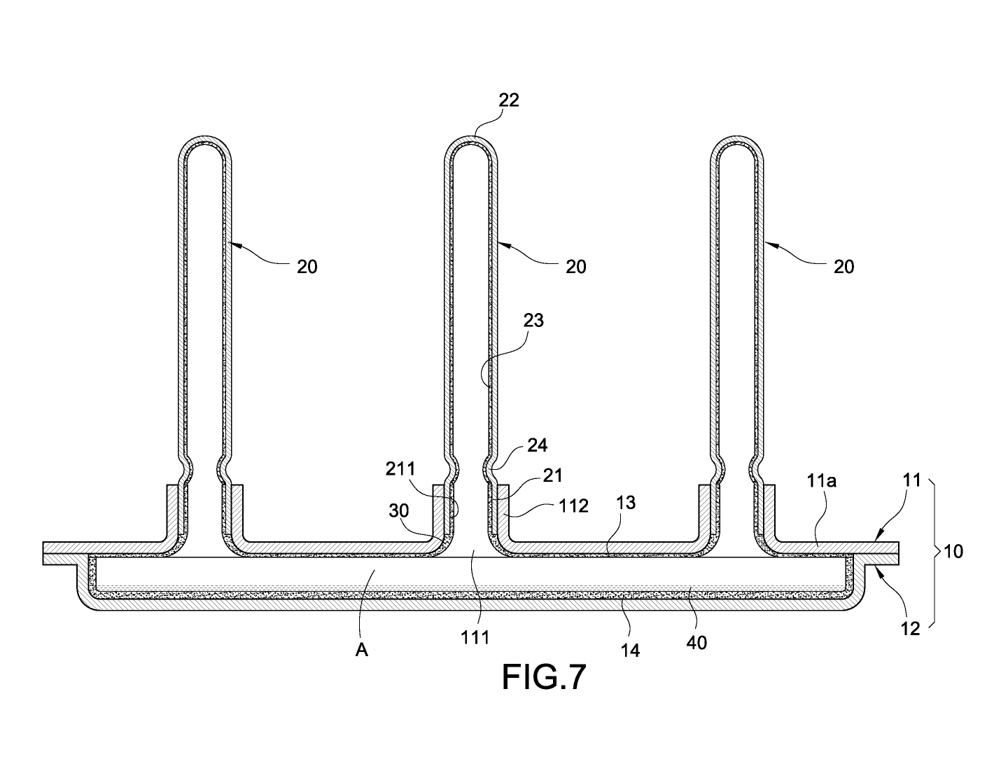

f) A sintering process is performed on a half-finished product of step e) to form a porous sintered structure 30 between the through hole 111 and the block portion 24 and to form an upper housing 11. Referring to FIG. 6, in this step, the half-finished product having the metallic powder 9 filled therein and having the metallic powder 9 sprayed thereon is sent into a heating apparatus to perform the sintering process. After completion of the sintering process, the core rod 8 is removed, so the porous sintered structure 30 (as shown in FIG. 7) is formed from around the through hole 111 to the block portion 24, and an upper housing 11 is formed. The porous sintered structure 30 produced after completing this step is connected to the first capillary structure 13 and the second capillary structure 23.

g) A lower housing is prepared 12, the lower housing 12 and the upper housing 11 are combined to be sealed with respect to each other. Referring to FIG. 7, in this step, the lower housing 12 has been processed in advance to form a cavity and a third capillary structure 14 in the cavity. The third capillary structure 14 can be a metallic woven web, a porous sintered powder element, or a groove element. The lower housing 12 and the upper housing 11 are sealed with respect to each other by welding to form a cavity A between the upper housing 11 and the lower housing 12.

h) A fluid filling process and a degassing sealing process are performed on the half-finished product of the step g). Referring to FIG. 7, in this step, a working fluid such as water or other fluid is filled into the cavity A via a fluid feeding degas pipe (not illustrated), and a fluid filling process, a degas sealing process and other processes are performed to complete production.

Referring to FIG. 7, the present invention provides an assembly structure of a heat pipe and a vapor chamber, comprising a vapor chamber 10, a heat pipe 20, a porous sintered structure 30, and a working fluid 40. The vapor chamber 10 includes a lower housing 12 and an upper housing 11 sealed with respect to the lower housing 12. A cavity A is formed between the upper housing 11 and the lower housing 12. A first capillary structure 13 is disposed inside the cavity A. The upper housing 11 includes a through hole 111 and a circular wall 112 extending from a circumference of the through hole 111. The heat pipe 20 includes an opening 211, a second capillary structure 23 is disposed inside the heat pipe 20, the heat pipe 20 is disposed perpendicularly corresponding to the circular wall 112 and communicates with the through hole 111 by means of the opening 211, and a block portion 24 is formed on the heat pipe 20 close to the opening 211. The porous sintered structure 30 is formed between the through hole 111 and the block portion 24 and is connected to the first capillary structure 13 and the second capillary structure 23. The working fluid 40 is filled into the cavity A.

When in use, the working fluid 40 in a liquid state is heated to be vaporized to be converted into a gaseous state, the working fluid 40 in the gaseous state carrying a large amount of heat flows to the opening 211 of each heat pipe 20 and reaches the close end 22 of the heat pipe 20. After the working fluid 40 in the gaseous state dissipates heat by using the heat pipes 20 in thermal contact with a plurality of heat dissipation plates (not illustrated), the working fluid 40 is condensed into the liquid state and flows back to the cavity A via the second capillary structure 23, the porous sintered structure 30 and the first capillary structure 13 sequentially. The first capillary structure 13 and second capillary structure 23 are connected via the porous sintered structure 30 to form a continuous reverse-flow path, thereby increasing a reverse-flow speed of the fluid.

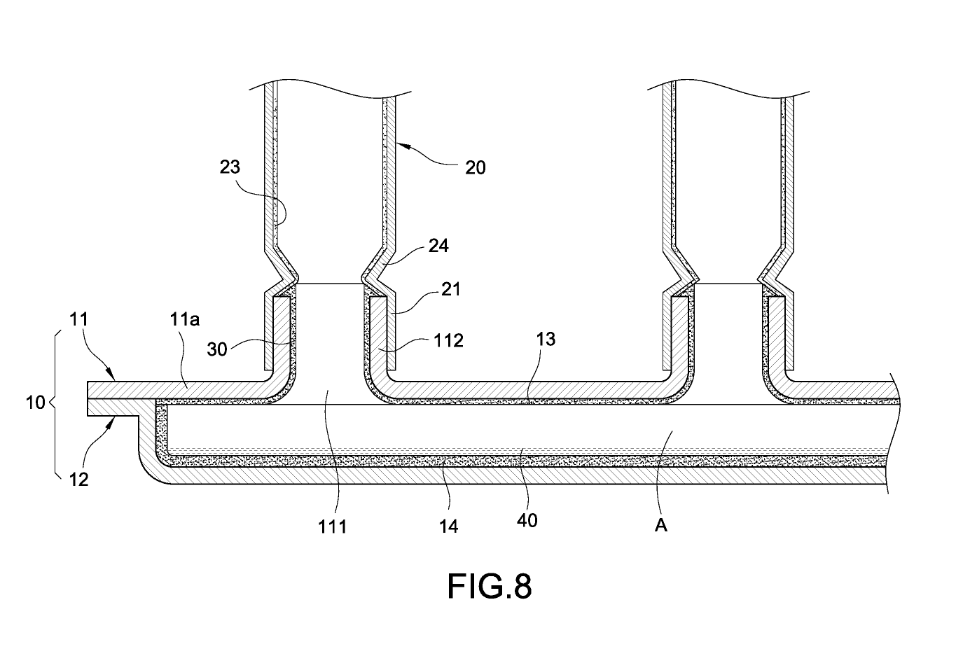

Referring to FIG. 8 concerning the assembly structure of the heat pipe and the vapor chamber of the present invention, in addition to the above-mentioned embodiment, an adhesive can be applied to an outer circumferential surface of the circular wall 112, then the open end 21 of the heat pipe 20 encloses the circular wall 112 to be connected and to allow the open end 211 to communicate with the through hole 111. In the embodiment, the circular wall 112 is accommodated inside the open end 21.

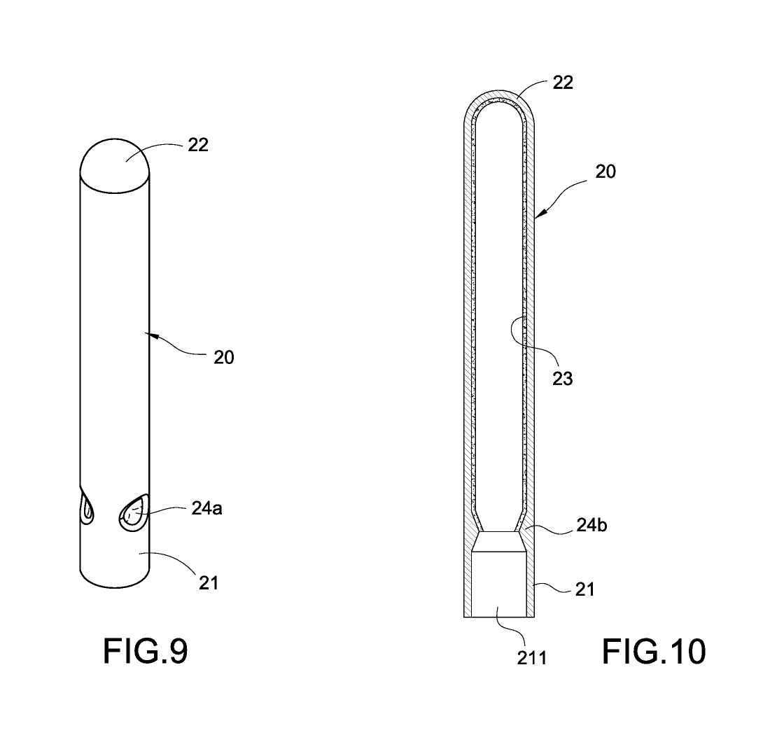

Referring to FIG. 9, the difference between the heat pipe in this present embodiment and the heat pipe in the above-mentioned embodiment is that the block portion 24a of the present embodiment includes a plurality of depressions at the open end 21 of the heat pipe 20 close to the opening 211 so as to block the core rod 8 upon insertion thereof.

Referring to FIG. 10, the block portion 24b in this embodiment directly forms an inner block annulus on the inner surface of the open end 21 of the heat pipe 20 close to the opening 211 so as to block the core rod 8 upon insertion thereof.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. An assembly method of a heat pipe and a vapor chamber, comprising the steps of:
a) preparing a metal board and processing the metal board to form a through hole and a circular wall;
b) preparing the heat pipe with an opening, processing the heat pipe to form a block portion;
c) arranging the heat pipe to be perpendicular corresponding to the circular wall to allow the opening to communicate with the through hole;
d) inserting a core rod from the through hole to be blocked by the block portion;
e) filling a metallic powder into an outer periphery of the core rod from the through hole;
f) performing a sintering process on a first half-finished product of step e) to form a porous sintered structure between the through hole and the block portion and form an upper housing;
g) preparing a lower housing and sealing the lower housing with respect to the upper housing; and
h) performing a fluid filling process and a degassing sealing process on a second half-finished product of step g).

2. The assembly method of the heat pipe and the vapor chamber of claim 1, wherein step b) is performed before step a).

3. The assembly method of the heat pipe and the vapor chamber of claim 1, wherein in step c), the heat pipe includes an open end, the opening is formed at the open end, and the open end is inserted through the circular wall to be accommodated inside the circular wall.

4. The assembly method of the heat pipe and the vapor chamber of claim 3, wherein the upper housing includes a first capillary structure, the heat pipe includes a second capillary structure, and the porous sintered structure in step f) is formed at an inner surface of the open end and is connected to the first capillary structure and the second capillary structure.

5. The assembly method of the heat pipe and the vapor chamber of claim 4, wherein the first capillary structure is a porous sintered powder element, and the porous sintered powder element is integral with the porous sintered structure.

6. The assembly method of the heat pipe and the vapor chamber of claim 1, wherein in step c), the heat pipe includes an open end, the opening is formed at the open end, and the open end encloses the circular wall to accommodate the circular wall inside the open end.

7. The assembly method of the heat pipe and the vapor chamber of claim 6, wherein the upper housing includes a first capillary structure, the heat pipe includes a second capillary structure, and the porous sintered structure in step f) is formed on an inner surface of the circular wall and is connected to the first capillary structure and the second capillary structure.

8. The assembly method of the heat pipe and the vapor chamber of claim 7, wherein the first capillary structure is a porous sintered powder element, and the porous sintered powder element is integral with the porous sintered structure.

9. An assembly structure of a heat pipe and a vapor chamber, comprising:
the vapor chamber including a lower housing and an upper housing sealed with respect to each other, a cavity being formed between the upper housing and the lower housing, the upper housing including a through hole and a circular wall extending from a circumference of the through hole;
the heat pipe including an opening, which is disposed perpendicularly corresponding to the circular wall and communicating with the through hole by means of the opening, a block portion being formed on the heat pipe close to the opening;
a porous sintered structure formed between the through hole and the block portion; and
a working fluid filled into the cavity.

10. The assembly structure of the heat pipe and the vapor chamber of claim 9, wherein a first capillary structure is disposed inside the cavity, a second capillary structure is disposed inside the heat pipe, and the porous sintered structure is connected to the first capillary structure and the second capillary structure.

11. The assembly structure of the heat pipe and the vapor chamber of claim 10, wherein the heat pipe includes an open end, the opening is formed at the open end, and the open end is inserted through the circular wall to be accommodated inside the circular wall.

12. The assembly structure of the heat pipe and the vapor chamber of claim 11, wherein the porous sintered structure is formed at an inner surface of the open end.

13. The assembly structure of the heat pipe and the vapor chamber of claim 10, wherein the heat pipe includes an open end, the opening is formed at the open end, and the open end encloses the circular wall to accommodate the circular wall inside the open end.

14. The assembly structure of the heat pipe and the vapor chamber of claim 13, wherein the porous sintered structure is formed at an inner surface of the circular wall.

15. The assembly structure of the heat pipe and the vapor chamber of claim 10, wherein the block portion is an annular recess formed on the heat pipe.

16. The assembly structure of the heat pipe and the vapor chamber of claim 10, wherein the block portion is a plurality of depressions formed on the heat pipe.

17. The assembly structure of the heat pipe and the vapor chamber of claim 10, wherein the block portion is an inner block annulus formed on an inner surface of the heat pipe.
